(19) United States
(12) Patent Application Publication
(10) Pub. No.: US 2013/0074570 A1
(43) Pub. Date: Mar. 28, 2013

(54) CLAMP MECHANISM FOR HOT ROLLING MILLS SPLIT GUIDES, INCLUDING WATER BOXES AND EQUALIZATION TROUGHS

(71) Applicants: William X. Shen, Boylston, MA (US); Jianping Zhang, Newton, MA (US); Brian Vallimont, Arlington, MA (US); Bruce V. Kiefer, Holden, MA (US)

(72) Inventors: William X. Shen, Boylston, MA (US); Jianping Zhang, Newton, MA (US); Brian Vallimont, Arlington, MA (US); Bruce V. Kiefer, Holden, MA (US)

(73) Assignee: SIEMENS INDUSTRY, INC., Alpharetta, GA (US)

(21) Appl. No.: 13/613,908

(22) Filed: Sep. 13, 2012

Related U.S. Application Data
(60) Provisional application No. 61/540,102, filed on Sep. 28, 2011.

(51) Int. Cl. B21D 31/00; B25B 1/06

(52) U.S. Cl. 72/364; 269/216

(57) ABSTRACT

Rolling mill split box guides, including water cooling nozzle and equalization trough assemblies are retained by a clamping mechanism that includes a header support structure having opposed front and back sides, for support of the split box there between. A clamp arm has a first end pivotally coupled to one of the header sides and a pivotal range of motion across the header and split box to the other side thereof. A threaded screw or other biasing actuator is coupled to the other of the header sides, selectively engageable with the clamp arm, for exerting biasing force on the split box.

### CROSS-REFERENCE TO RELATED APPLICATIONS

This application claims the benefit of co-pending U.S. provisional patent application filed Sep. 28, 2011 and assigned Ser. No. 61/540,102, which is incorporated by reference herein.

### BACKGROUND

1. Field of the Invention

Embodiments of the present invention relate to clamp mechanisms suitable for application in hot rolling mills and more particularly to a clamp mechanism suitable for retaining split box structures, including split guides, that may be used in cooling system water box nozzle assemblies and equalization troughs.

2. Description of the Prior Art

Steel bars and rods are produced by hot rolling, steel billets in a continuous hot rolling process. During different steps of the rolling process the rolled products may require motion restraint, so that they follow a designated transport path, temperature equalization or quenching by application of cooling water.

After the metal forming steps, the rolled products are conveyed along one or more lines running through sequential split box structures, also known as split guides, which are analogous to tunnels that direct them along desired paths. Water box cooling lines spray the hot rolled product surface with pressurized water. Nozzle assemblies include a plurality of annular shaped nozzles that are retained within the split shell nozzle assembly boxes. The annular nozzles spray water on the hot metal that is transported through the nozzle annular interiors. Nozzle assemblies and their split shell boxes are sequentially arrayed along the cooling line and are of known construction. The nozzle assemblies are in communication with a pressurized water manifold, and must be held in fixed position to avoid water leaks and potential loss of cooling efficiency if insufficient flow and/or pressure are not maintained at each nozzle due to leaking water diversion. Temperature equalization troughs also transport hot metal rolled products via internal pathways within static guide split shell box structures, but do not apply a cooling fluid. Rather, equalization troughs reduce or minimize further temperature loss from the product surface, thereby allowing heat to “soak” out from the interior; i.e., “equalizing” the temperature between the interior and the exterior of the hot rolled product.

Conventionally rolling mill line split guide structure water box nozzle assemblies and equalization troughs have been held in fixed position by screw driven manual “C clamps”, such as shown in U.S. Pat. No. 5,257,511, the entire contents of which is incorporated herein by reference. An exemplary known split guide structure 10 with a C clamp is shown in FIG. 1. The structure 10 includes a header 20, with a bottom surface 22, upon which is affixed a split guide box 30 having a lower half 32 and an upper half 36. The split guide box 30 has complimentary hinged ears 34A, 38A through which a hinge rod 39 is retained, so that the box is capable of being pivoted from the shown closed position to an open position. The split guide box 30 is often fabricated with a complementary set of mirror image hinged ears 34B, 38B on the opposite side, to facilitate pivoting opening from the other side, if desired. A pivot flange 24 projects downwardly from the header bottom surface 22 in order to receive C clamp 40 pivoting axle 44, so that the clamp is capable of pivoting motion. The C clamp 40 has an upper flange 42 that retains clamp foot 46 and threaded drive screw 48. Rotation of the clamp handle 49 to tighten the screw 48 imparts a compressive force F_{C} along the split guide box 30 centerline between the clamp foot 46 and the pivoting axle 44. In order to avoid nozzle leakage and potential loss of cooling efficiency, each individual C clamp is hand tightened by mill personnel to a torque specification necessary to achieve a desired compressive force F_{C}, which is often sufficiently high to bow the header bottom surface 22 and cause excessive stress S at the juncture of the upper flange 42 and remainder of the C clamp 40. The lower flange that receives the pivot axle 44 is also subject to the same excessive stress S where it joins the remainder of the C clamp 40.

An alternative to split guide nozzle assembly retention by C clamps is disclosed in U.S. Patent Publication No. US 2010/0006188 A1, the entire contents of which are incorporated herein by reference. The Publication discloses use of a remote actuated pivoting clamp support that may be coupled to a plurality of nozzle assemblies for simultaneous clamping of a series of sequential nozzle assemblies along a cooling line. One tong lateral side of the clamp support is pivotally engaged with the water box frame that retains the sequence of nozzle assemblies in an array. The other lateral side of the clamp support is linked to a pivoting shaft that is driven by an actuator. When the driven shaft pivots, the other lateral side of the clamp support may be swung from an open to a closed position. Rotating torque force must be maintained on the driven shaft in order to retain the nozzle assembly in the closed or “clamped” position, requiring constant energy consumption and wear and tear on the actuator and entire linkage assembly. The pivoting shaft and linkage does not maintain constant force on each serial nozzle assembly due to deflection variations along the shaft length. Thus a higher than otherwise needed constant force is applied to the shaft assembly by the actuator in order to assure that each individual nozzle assembly meets minimum clamping force specifications. In turn, a larger actuator and pivoting shaft is required to generate and transfer the higher force needed to assure clamping of each nozzle assembly within minimum specification. Larger actuators and shaft structures necessitate greater energy consumption during operation and use of additional material for construction strength. The angular linkage also stresses the water box frame as the actuator exerts clamping force on the nozzle assembly,

Another alternative to split guide nozzle assembly retention by C clamps is disclosed in U.S. patent application Ser. No. 13/162,764, filed Jun. 17, 2011, the entire contents of which are incorporated herein by reference. Rolling mill split box guide nozzle and equalization trough assemblies are retained by a remote actuated clamping mechanism that includes a central pivoting elongated clamp member having an engagement surface proximal one end that engages the clamped object, and a link pivot proximal the other end. A pivoting link has a first end pivotally coupled to the clamp member link pivot and a second end that is pivotally coupled to an actuator shaft The actuator shaft is capable of translation to a locked position that maintains engagement between the clamp member and the clamped split box nozzle assembly or equalization trough object, wherein the link blocks clamp member motion. The actuator shaft is also capable of translation to an unlocked position that enables clamp member pivoting motion out of engagement with the clamped object. The actuator shaft may be translated by an actuator controlled by a factory automation system.

### SUMMARY

Briefly described, embodiments of the present invention relate to the creation of a clamping mechanism for improving the seating and clamping of a water box in a rolling mill. Among other things, the clamping mechanism improves clamping effectiveness, eases access to nozzles in the water box, reduces weight of the clamping mechanism, equalizes load applications to the front and back nozzle mating surfaces, links the nozzles and clamps, and equalizes troughs located before and after the water box.

Conventionally, as described in the Background of this Application, in split box water box applications, each nozzle was manually clamped with a “C” clamp. As water box nozzle pressures have increased, however, the capacity and reliability of this conventional clamp have become a limitation to rolling mills and its effectiveness has been significantly reduced. Aspects of the present invention overcome and are significant improvements over conventional C clamps and are adapted to handle high nozzle loading reliably, while reducing mechanism size, weight and cost.

In an exemplary embodiment, the clamping mechanism of the present invention is a cost-effective solution to improve nozzle clamping of water boxes and other split box structures including equalization troughs. The clamping mechanism features an offset clamp that can pivots at the front or back, rather than at the bottom, as conventionally available. The clamp mechanism of the present invention utilizes offset leverage from the split box front and back, which requires less clamping force generation by the clamping screw structure. The present invention clamp mechanism also reduces clamping span, which can reduce the stress and deflection of the clamp, therefore increasing the clamp's capacity. Because of the lower stresses, various claim components can be made smaller and thus utilize less material.

Accordingly, embodiments of the present invention include a clamp mechanism for clamping hot rolling mill cooling line split boxes, having a header support structure with opposed front and back sides, for support of a split box there between. A clamp arm having a first end is pivotally coupled to one of the header sides. The clamp arm has a pivotal range of motion across the header to the other side. A biasing actuator is coupled to the other of the header sides, selectively engageable with the clamp arm, for exerting biasing force on a split box that is supported by the header. The biasing actuator may be a threaded screw or a cam lever.

Embodiments of the present invention also feature a hot rolling mill cooling line apparatus, comprising a header support structure having opposed front and back sides, for support of a split box there between. The apparatus also includes a split box having opposed front and back sides corresponding to those of the header, as well as upper and lower halves that pivot relative to each other along the back side. The split box may be a water box or an equalization trough. A clamp arm having a first end is pivotally coupled to the header back side. The clamp arm has a pivotal range of motion across the header and split box to the respective front sides thereof. A biasing actuator is coupled to the header front side, selectively engageable with the clamp arm, for exerting biasing force on the split box halves.

Other embodiments of the present invention feature a hot rolling mill cooling line apparatus, including a header support structure having opposed front and back sides, for support of a split box there between. A saddle is coupled to the header on the front and back sides, having a saddle pivoting axis on the back side. A split box having opposed front and back sides corresponding to those of the header as well as upper and lower halves that are pivotal relative to each other along the back side is supported by the support structure. A clamp arm having a first end is pivotally coupled to the saddle pivoting axis and has a pivotal range of motion across the header and split box to the respective front sides thereof. A biasing actuator exerts biasing force on the split box halves, and is pivotally coupled to the saddle on the header front side. The biasing actuator has a range of motion that is selectively engageable with the clamp arm in a closed position and laterally extending away from the header front side in an open position.

The features of the present invention may be applied jointly or severally in any combination or sub-combination by those skilled in the art.

### BRIEF DESCRIPTION OF THE DRAWINGS

The teachings of the present invention can be readily understood by considering the following detailed description in conjunction with the accompanying drawings, in which:

FIG. 1 shows a front devotional view of a prior art split guide box water box and trough clamping mechanism;

FIG. 2 shows a front elevational perspective view of a split guide box water box and trough clamp mechanism in accordance with an embodiment of the present invention;

FIG. 3 shows a rear devotional perspective view of the split guide box water box and trough clamp mechanism of FIG. 2;

FIG. 4 shows a front devotional view of the clamp mechanism of FIGS. 2 and 3 in a closed position;

FIG. 5 shows a front elevational view of e clamp mechanism of FIGS. 2 and 3 in an open position;

FIG. 6 shows a partial elevational cross sectional view of the clamp mechanism of FIG. 2, taken along 6-6 thereof; and

FIG. 7 shows a front devotional view of an alternative embodiment clamp mechanism of the present invention in a closed position.

To facilitate understanding, identical reference numerals have been used, where possible, to designate identical elements that are common to the figures.

### DETAILED DESCRIPTION

To facilitate an understanding of embodiments, principles, and features of the present invention, they are explained hereinafter with reference to implementation in illustrative embodiments. In particular, they are described in the context of being an improved clamping mechanism, preferably for a split box, such as a water box or equalization trough, in a rolling mill cooling line system. Embodiments of the present invention, however, are not limited to use in the described systems.

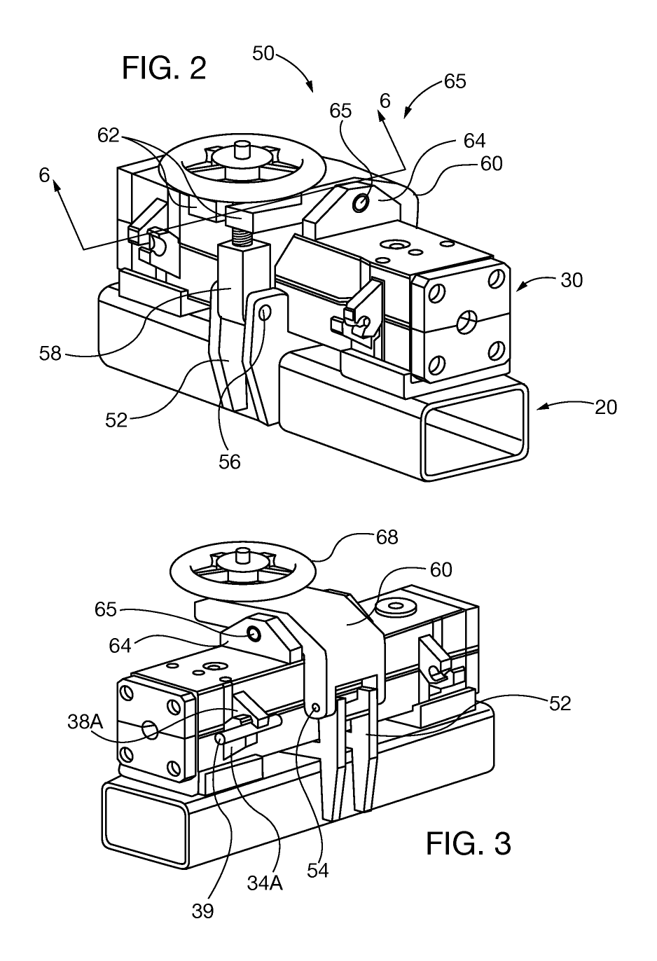

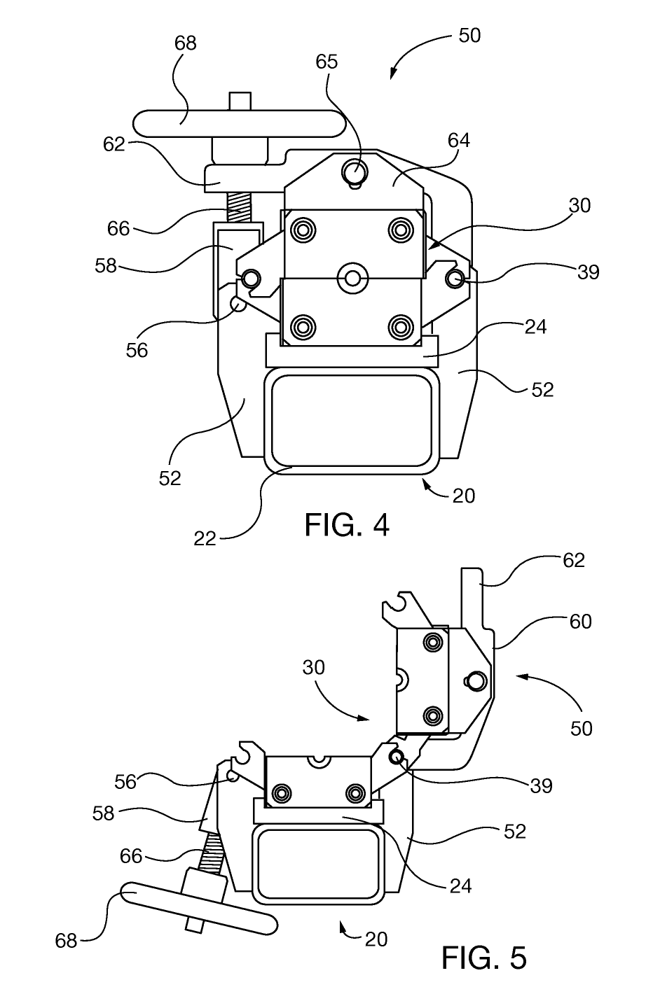

As illustrated in FIGS. 2-5, the clamping mechanism 50 includes a header support structure 20 having a bottom surface 22, a top surface opposite the bottom surface, as well as opposed front and back sides, with the front side shown in FIG. 2 and the back side shown in FIG. 3. A split box 30, shown as a water cooling box, has front and rear sides corresponding to those of the header 20 and is supported on the header 20 top surface by support blocks 24. The split guide box 30 has complimentary hinged ears 34A, 38A through which a hinge rod 39 is retained, so that upper and lower halves of the box are capable of being pivoted from the shown closed position of FIG. 4 to an open position shown in FIG. 5. The split guide box 30 is fabricated with a complementary set of mirror image hinged ears on the opposite side, to facilitate pivoting opening from the other side, if desired. A saddle 52 is coupled to the header support structure 20 top front and back sides, by any known joining method, including but not limited to by welding, so that clamping loads are distributed over a relatively large part of the header structure. The saddle includes a clamp pin 54 on the back side of the header 20 and an actuator pin 56 on the front side of the header.

Clamp pin 54 is pivotally coupled to a first end of clamp arm 60. As is shown in respective FIGS. 4 and 5, the clamp arm 60 selectively pivots from a closed position to an open position in the same direction as the water cooling box 30. In the closed position the clamp arm straddles both the header 20 and the split water cooling box 30. The second end of clamp arm 60 has a pair of projecting ears 62 that define a gap between them, for receipt of threaded screw 66 that is manually rotated by handle 68. A female internally threaded block 58 receives the threaded screw 66, and is pivotally coupled to the actuator 56, so that the block, screw, and handle 68 can swing from an engaged position with the clamp arm 60 as shown in FIG. 4 to an open position shown in FIG. 5 that facilitates unobstructed access to the water cooling box 30. When the clamp arm 60 is in its closed position and engages the threaded screw 66 between the second end ears 62, rotation of the handle 68 biases the clamp arm toward the header 20, compressing the split water box 30 halves into contact with each other. Clamp load foot 64 is pivotally coupled to the clamp arm 60 by clamp load foot pin 65, and abuts against the split water cooling box 30 top half as the biasing actuator threaded screw 66 compresses the water cooling box. Pivoting attachment of the clamp load foot 64 to the clamp arm 60 compensates for surface misalignment between the header 20, split water cooling box 30 and clamp arm 60.

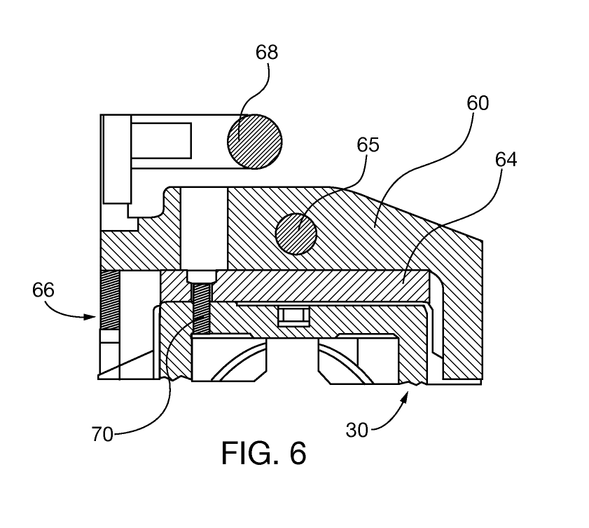

FIG. 6 shows an additional embodiment of the present invention that includes a threaded fastener 70 for coupling the clamp load foot 64 to the split water box 30 top half, so that pivoting the clamp arm 60 opens and closes a split box. Other known coupling mechanisms may be substituted for the threaded fastener 70.

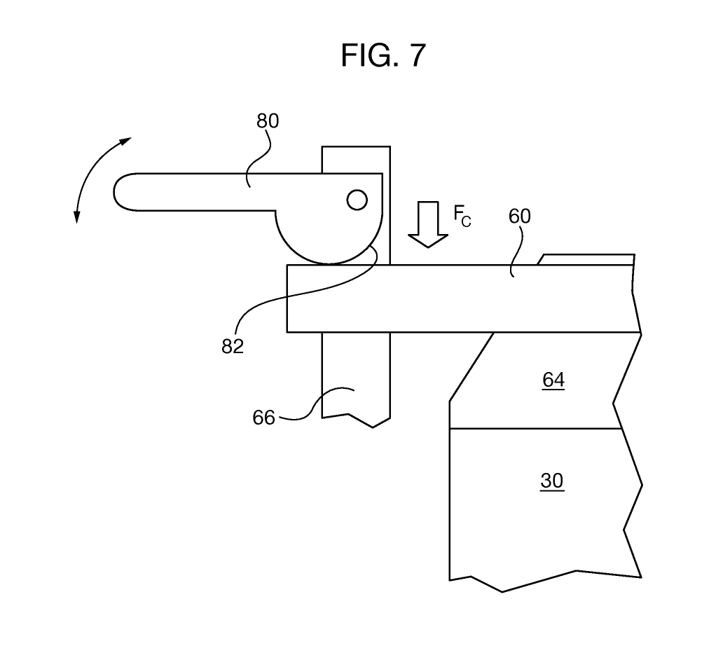

FIG. 7 shows an additional embodiment of biasing actuator for biasing the split box 30 halves toward each other. Here a toggle lever 80 having a camming surface 82 biases against the clamp arm 60 and compresses the split box 30 halves. Other known biasing actuators may be substituted for the lever 80 or the threaded block 58/screw 66/handle 68. Alternatively the threaded block 58 and screw 66 may be retained for coarse biasing adjustment and the toggle lever 80 substituted for the rotating handle 68.

Potential Benefits of the Present Invention

The present invention offers the following potential benefits, which may be applied jointly or severally in any combination or sub-combination.

Clamping Effectiveness

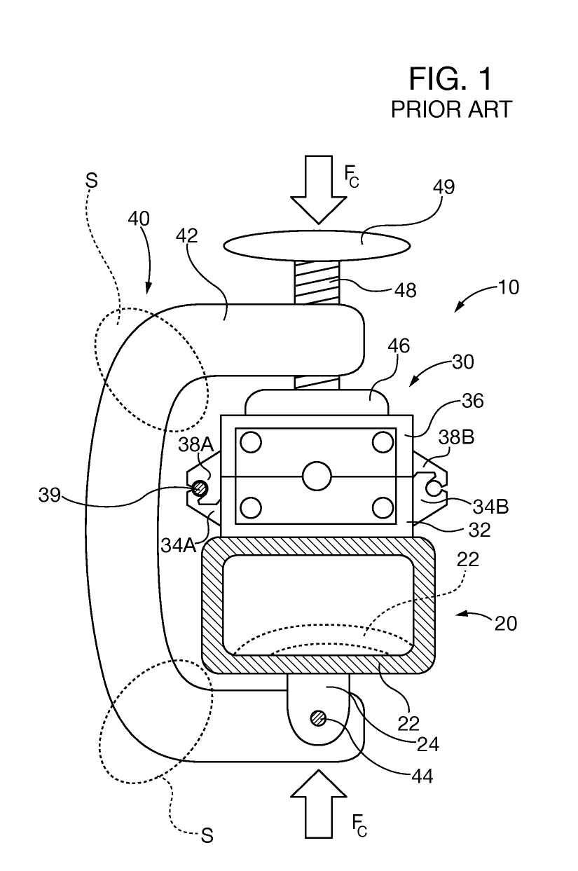

Clamping effectiveness, and therefore nozzle efficiency, is improved with the present clamping mechanism 50 by means of increased stiffness in the clamping mechanism due to the shorter clamping span. The clamping span of clamping mechanism 50 is effectively the distance between the clamp pin 54 and the threaded screw 66. This increased stiffness reduces deflection and stress in the clamping mechanism, thereby holding the split water box 30 nozzle halves together more effectively and improving sealing in the nozzle when under pressure. In comparison the conventional clamp 40 of FIG. 1 has an effective clamping span between the base of the clamp foot 46 and the pivoting axle 44.

In addition, the present clamping mechanism 50 may be constructed to anchor to three sides of the header 20, rather than mounting only to the bottom common in conventional designs shown in FIG. 1. This approach distributes the load applied to the header more widely and further reduces header deflection. By reducing the deflection this feature also benefits clamping capacity and effectiveness.

Nozzle Access

The present clamping mechanism improves service access to the nozzles in the split water box 30. In the conventional design of FIG. 1, the clamp 40 swings only partially to the front, (i.e., to the left or counterclockwise in the figure), which still partially obstructs water cooling box 30 and access to its internal nozzles. In contrast, the present clamping system, as shown in FIG. 5, the clamp arm 60 swings to the back and the biasing actuator handle 68/clamp screw 66 block 58 swings down and out of the way to the front, allowing full, unrestricted access to the split box 30 internal nozzles. By having full access to the nozzles, service technicians can quickly assemble and/or service the water cooling box 30, resulting in less downtime of the and reducing costs associated with downtime.

Weight Reduction

Aspects of the present invention are adapted to minimize weight of the clamping mechanism 50, because of the smaller sized components, when compared to a conventional water nozzle clamping assembly 40 of FIG. 1. These smaller sized components can further improve ease of use and manipulation.

Equalized Load Application to the Front and Back Nozzle Mating Surfaces

Aspects of the present invention also can feature a pivoting clamp foot 64 that can apply the clamp load equally to the front and back sealing surfaces of the split nozzle box 30. This can ensure that both the front and back of the nozzle box are clamped effectively and further enhances nozzle efficiency. The same benefits are applicable to equalization trough split boxes,

Nozzle and Clamp Linkage

Aspects of the present invention can also feature a coupling link between the pivoting clamp foot and the split box water cooling box 30 which houses coolant nozzles, such that both can be opened in one single, smooth operation. This can be carried out by means of fastener screw 70, which loosely holds the pivoting clamp foot to the split box 30 top half. Among other things, this feature can improve ease of use when opening and closing split boxes containing nozzle assemblies, for easier nozzle service access. FIG. 6 illustrates a portion of the clamping mechanism 50, which can comprise an attachment mechanism, as illustrated being an attachment screw 70, and a clamp load foot 64.

Application to Equalization Troughs

Aspects of the present invention are adapted to be applicable to split box equalization troughs, which are typically located before, between and after water boxes and between other pieces of equipment in the rolling mill. In the case of the equalization troughs, much less force is usually required to hold the halves of the split-design troughs together, because there is no water pressure trying to force the halves apart. Therefore, instead of the wheel and screw, a simpler and less expensive mechanism such as a toggle clamp 80 with a cam surface 82 mounted on the pivot point of the toggle clamp can be implemented, as is shown in FIG. 7.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. The components and materials described hereinafter as making up the various embodiments are intended to be illustrative and not restrictive. Many suitable components and materials that would perform the same or a similar function as the materials described herein are intended to be embraced within the scope of embodiments of the present invention. Also, it is to be understood that the phraseology and terminology used herein is for the purpose of description and should not variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

What is claimed is:

1. A remote actuated pivoting clamp mechanism for clamping hot rolling mill cooling line split boxes, comprising:
a header support structure having opposed front and back sides, for support of a split box there between;
a clamp arm having a first end pivotally coupled to one of the header sides, the clamp arm having a pivotal range of motion across the header to the other side thereof; and
a biasing actuator coupled to the other of the header sides, selectively engageable with the clamp arm, for exerting biasing force on a split box that is supported by the header.

2. The mechanism of claim 1, the biasing actuator comprising a threaded screw.

3. The mechanism of claim 1, the biasing actuator comprising a cam lever.

4. The mechanism of claim 1, the biasing actuator pivotally coupled to the other of the header sides, having a range of motion engaged with the clamp arm in a closed position and laterally extending away from the other of the header sides in an open position.

5. The mechanism of claim 4, the clamp arm having a second end having a pair of clamp ears defining a slot there between for receipt of the biasing actuator therein when the clamp arm is in a closed position.

6. The mechanism of claim 4, the biasing actuator comprising a threaded screw.

7. The mechanism of claim 1, comprising a saddle coupled to the header on the front and back sides, having a saddle pivoting axis coupled to the clamp arm first end.

8. The mechanism of claim 7, the biasing actuator pivotally coupled to the saddle on the other of the header sides, having a range of motion engaged with the clamp arm in a closed position and laterally extending away from the other of the header sides in an open position.

9. The mechanism of claim 1 comprising a clamp load foot coupled to the clamp arm facing the header, for abutting engagement with a split box that is supported by the header when the clamp arm engaged with the biasing actuator.

10. The mechanism of claim 9, the clamp load foot pivotally coupled to the clamp arm.

11. The mechanism of claim 9, the clamp load foot having a split box coupling element for coupling to a split box, so that pivoting the clamp arm opens and closes a split box that is coupled to the clamp load foot.

12. A hot rolling mill cooling line apparatus, comprising:
a header support structure having opposed front and back sides, for support of a split box there between;
a split box having:
opposed front and back sides corresponding to those of the header,
upper and lower halves pivotal relative to each other along the back side;
a clamp arm having a first end pivotally coupled to the header back side, the clamp arm having a pivotal range of motion across the header and split box to the respective front sides thereof; and
a biasing actuator coupled to the header front side, selectively engageable with the clamp arm, for exerting biasing force on the split box halves.

13. The apparatus of claim 12, the biasing actuator pivotally coupled to the header front side, having a range of motion engaged with the clamp arm in a closed position and laterally extending away from the other of the header sides in an open position.

14. The apparatus of claim 13, the clamp arm having a second end having a pair of clamp ears defining a slot there between for receipt of the biasing actuator therein when the clamp arm is in a closed position.

15. The apparatus of claim 12, comprising a saddle coupled to the header on the front and back sides, having a saddle pivoting axis coupled to the clamp arm first end, the biasing actuator pivotally coupled to the saddle on the header front side, having a range of motion engaged with the clamp arm in a closed position and laterally extending away from the header front side in an open position.

16. The apparatus of claim 12 comprising a clamp load foot coupled to the clamp arm facing the header, for abutting engagement with the split box when the clamp arm is engaged with the biasing actuator.

17. The apparatus of claim 116, the clamp load foot pivotally coupled to the clamp arm.

18. The apparatus of claim 16, the clamp load foot coupled to the split box upper half, so that pivoting the clamp arm opens and closes the split box.

19. A hot rolling milt cooling line apparatus, comprising:
a header support structure having opposed front and back sides, for support of a split box there between;
a saddle coupled to the header on the front and back sides, having a saddle pivoting axis on the back side;
a split box having:
opposed front and back sides corresponding to those of the header,
upper and lower halves pivotal relative to each other along the back side;
a clamp arm having a first end pivotally coupled to the saddle pivoting axis, the clamp arm having a pivotal range of motion across the header and split box to the respective front sides thereof; and
a biasing actuator, for exerting biasing force on the split box halves, pivotally coupled to the saddle on the header front side, having a range of motion that is selectively engageable with the clamp arm in a closed position and laterally extending away from the header front side in an open position.

20. The apparatus of claim 19, comprising:
a clamp load foot pivotally coupled to the clamp arm facing the header, for abutting engagement with the split box top half when the clamp arm is engaged with the biasing actuator;
the clamp arm having a second end having a pair of clamp ears defining a slot there between for receipt of the biasing actuator therein when the clamp arm is in a closed position; and
the biasing actuator is a threaded screw.
